(19) United States
(12) Patent Application Publication
(10) Pub. No.: US 2016/0351308 A1
(43) Pub. Date: Dec. 1, 2016

(54) NON-ORIENTED ELECTRICAL STEEL SHEET HAVING EXCELLENT MAGNETIC PROPERTIES

(71) Applicant: JFE STEEL CORPORATION, Tokyo (JP)

(72) Inventors: Yoshihiko Oda, Tokyo (JP); Tadashi Nakanishi, Tokyo (JP); Shinji Koseki, Tokyo (JP); Tomoyuki Okubo, Tokyo (JP)

(21) Appl. No.: 15/111,310

(22) PCT Filed: Jan. 8, 2015
(86) PCT No.: PCT/JP2015/050317

§ 371 Date: Jul. 13, 2016

(30) Foreign Application Priority Data
Jan. 14, 2014 (JP) 2014-003983

(51) Int. Cl. H01F 1/04; C22C 38/00; C22C 38/04; C22C 38/02; C22C 38/60; C22C 38/06

(52) U.S. Cl. CPC H01F 1/04; C22C 38/60; C22C 38/06; C22C 38/04; C22C 38/02; C22C 38/008; C22C 38/004; C22C 38/002; C22C 38/001

(57) ABSTRACT

A non-oriented electrical steel sheet has a high magnetic flux density and a low iron loss contains in terms of mass %, C: not more than 0.010%, Si: 1-4%, Mn: 0.05-3%, Al: not more than 0.004%, N: not more than 0.005%, P: 0.03-0.20%, S: not more than 0.01% and Se: not more than 0.002% or contains in terms of mass, C: not more than 0.01%, Si: 1-4%, Mn: 0.05-3%, Al: not more than 0.004%, N: not more than 0.005%, P: 0.03-0.20%, S: not more than 0.01%, Se: not more than 0.003% and further contains one or two selected from Sn: 0.001-0.1 mass % and Sb: 0.001-0.1 mass %.

### TECHNICAL FIELD

This disclosure relates to a non-oriented electrical steel sheet having excellent magnetic properties and, more particularly, to a non-oriented electrical steel sheet having a high magnetic flux density.

### BACKGROUND

Recently, high-efficiency induction motors are used in view of the increasing demand to save energy. To improve the efficiency of the high-efficiency induction motor, a laminate thickness of a core is made thick, or a filling rate of winding wires is increased, or an electrical steel sheet used as a core is exchanged from the conventional low-grade material to a high-grade material having a lower iron loss.

The core material used in the induction motor is required to be low in not only iron loss, but also the effective excitation current at a predetermined magnetic flux density to lower the effective excitation current to decrease copper loss. To reduce the excitation current, it is effective to increase a magnetic flux density of the core material. Further, a driving motor used in hybrid cars and electric cars, which is rapidly becoming popular, is necessary to have high torque at startup and during acceleration so that it is desired to further increase the magnetic flux density.

As an electrical steel sheet having an increased magnetic flux density, for example, JP-A-2000-129410 discloses a non-oriented electrical steel sheet in which 0.1-5 mass % of Co is added to a steel having not more than 4 mass % of Si.

However, since Co is a very expensive element, if the technique disclosed in JP '410 is applied to an ordinary motor, there is a problem that the raw material cost is extraordinarily increased. Therefore, it would be helpful to provide a non-oriented electrical steel sheet having a high magnetic flux density and a low iron loss cheaply and stably.

### SUMMARY

We found that a magnetic flux density can be largely increased by decreasing Se inevitably incorporated into a steel having a reduced Al content and an added P content to an ultralow level. We thus provide:
A non-oriented electrical steel sheet having a chemical composition comprising C: not more than 0.010 mass %, Si: 1-4 mass %, Mn: 0.05-3 mass %, Al: not more than 0.004 mass %, N: not more than 0.005 mass %, P: 0.03-0.20 mass %, S: not more than 0.01 mass %, Se: not more than 0.002 mass % and the remainder being Fe and inevitable impurities.
The non-oriented electrical steel sheet is characterized by further containing one or two of Sn: 0.001-0.1 mass % and Sb: 0.001-0.1 mass % in addition to the above chemical composition.
Also, the non-oriented electrical steel sheet is characterized by further containing one or two of Ca: 0.001-0.005 mass % and Mg: 0.001-0.005 mass % in addition to the above chemical composition.
Further, the non-oriented electrical steel sheet is characterized in that a sheet thickness is 0.05-0.30 mm.

A non-oriented electrical steel sheet having a high magnetic flux density can be provided cheaply and stably so that it can be preferably used as a core material for a high-efficiency induction motor, a driving motor of a hybrid car and an electric car requiring a high torque, and a high-efficiency electric generator requiring a high generation efficiency.

### BRIEF DESCRIPTION OF THE DRAWINGS

FIG. 1 is a graph showing an influence of P content upon a magnetic flux density B₅₀ after a finish annealing.

FIG. 2 is a graph showing an influence of Se content upon a magnetic flux density B₅₀ after a finish annealing.

### DETAILED DESCRIPTION

Hereinafter, experiments will be described.

### Experiment 1

At first, to investigate the influence of P upon magnetic flux density, steels prepared by adding P variously changed within a range of tr.-0.16 mass % to an Al-less steel containing C: 0.0020 mass %, Si: 3.07 mass %, Mn: 0.24 mass %, Al: 0.001 mass % and N: 0.0021 mass %, P: 0.01 mass % and S: 0.0021 mass % and an Al-added steel containing C: 0.0022 mass %, Si: 2.70 mass %, Mn: 0.24 mass %, Al: 0.30 mass % and N: 0.0018 mass %, P: 0.01 mass % and S: 0.0013 mass % are melted in a laboratory to form steel ingots, which are hot rolled to form hot rolled sheets of 1.6 mm in thickness. Thereafter, the hot rolled sheets are subjected to a hot band annealing at 980° C. for 30 seconds, pickled and cold rolled to form cold rolled sheets having a thickness of 0.20 mm, which are further subjected to a finish annealing at 1000° C. in an atmosphere of 20 vol % H₂-80 vol % N₂ for 10 seconds.

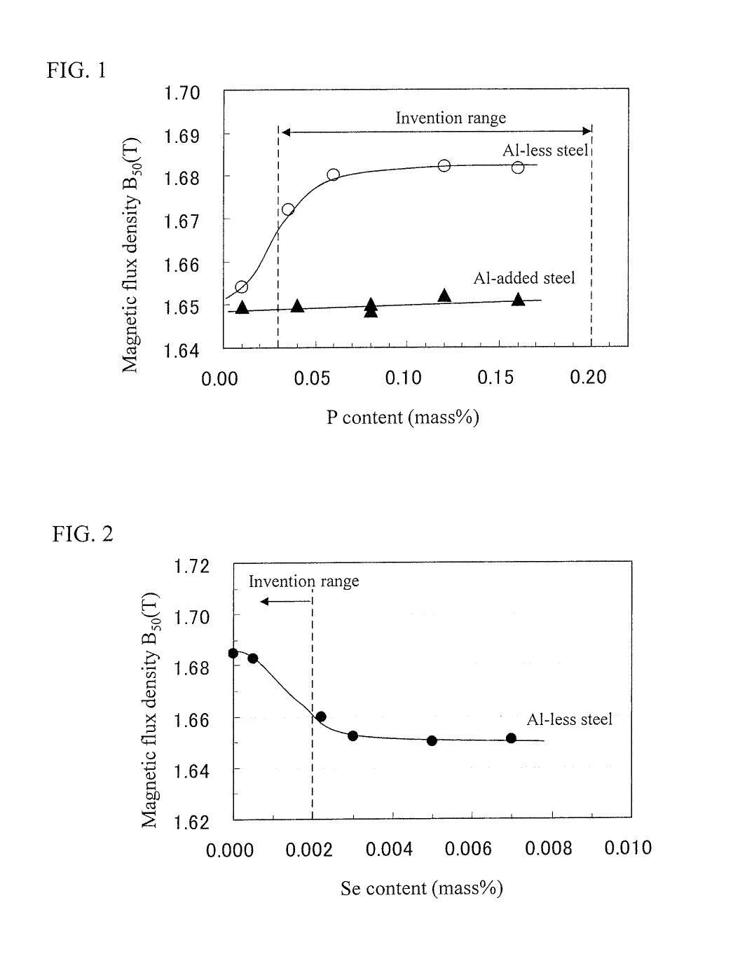

From the cold rolled and annealed sheets thus obtained are cut out test specimens with a width of 30 mm and a length of 280 mm in a rolling direction (L-direction) and in a direction perpendicular to the rolling direction (C-direction) as a length direction, respectively, to measure a magnetic flux density B₅₀ by a 25 cm Epstein method described in JIS C2550, the results of which are shown in FIG. 1 as a relation to P content. As seen from FIG. 1, an improvement of the magnetic flux density is not recognized in the Al-added steel even when P content is increased, whereas the magnetic flux density is improved in the Al-less steel with an increase of P content.

The reason why the magnetic flux density is improved with an increase of P content in the Al-less steel as described above is not sufficiently clear at present, but it is believed that Al somewhat affects the segregation behavior of P before the cold rolling and the diffusion rate of P is increased by containing no Al to promote the segregation of P into the crystal grain boundary to thereby improve the texture.

### Experiment 2

Then, to investigate the production stability of P-added steel, an Al-less steel containing C: 0.0018 mass %, Si: 3.10 mass %, Mn: 0.20 mass %, Al: 0.001 mass %, N: 0.0015 mass %, P: 0.06 mass % and S: 0.0014 mass % is tapped at 10 charges and hot rolled to form hot rolled sheets of 1.6 mm in thickness. The hot rolled sheets are subjected to a hot band annealing at 980° C. for 30 seconds, pickled and cold rolled to obtain cold rolled sheets each having a thickness of 0.20 mm, which are subjected to a finish annealing at 1000° C. in an atmosphere of 20 vol % H₂-80 vol % N₂ for 10 seconds to obtain cold rolled and annealed sheets.

When the magnetic flux density B₅₀ is measured as to the cold rolled and annealed sheets thus obtained in the same way as in Experiment 1, it becomes clear that the measured results are largely varied. As a composition analysis is performed in steel sheets having a low magnetic flux density, we found that Se is included in an amount of 0.0022-0.0035 mass %. From this result, it is inferred that Se is segregated into the grain boundary to suppress the segregation of P into the grain boundary and hence the magnetic flux density is decreased. We believe that Se is an element contained in scrap or the like and is incorporated inevitably with the increase of the use rate of the scrap in recent years.

### Experiment 3

Therefore, to investigate the influence of Se upon the magnetic flux density, steels prepared by adding Se variously changed within a range of tr.-0.007 mass % to a steel containing C: 0.0013 mass %, Si: 3.21 mass %, Mn: 0.15 mass %, Al: 0.002 mass % and N: 0.0018 mass %, P: 0.05 mass % and S: 0.0009 mass % are melted in a laboratory to form steel ingots, which are hot rolled to form hot rolled sheets of 1.6 mm in thickness. Then, the hot rolled sheets are subjected to a hot band annealing at 1000° C. for 30 seconds, pickled and cold rolled to obtain cold rolled sheets each having a thickness of 0.20 mm, which are subjected to a finish annealing at 1000° C. in an atmosphere of 20 vol % H₂-80 vol % N₂ for 10 seconds.

From the cold rolled and annealed sheets are cut out test specimens with a width of 30 mm and a length of 280 mm to measure a magnetic flux density B₅₀ in the same way as in the above experiment. The results are shown in FIG. 2 as a relation to Se content. As seen from FIG. 2, the magnetic flux density is decreased when Se content exceeds 0.0020 mass % and, hence, it is necessary to restrict the Se content to not more than 0.0020 mass %.

The chemical composition in our non-oriented electrical steel sheet will be described below.

C: not more than 0.010 mass %

Since C is a harmful element deteriorating iron loss, a lesser amount is more prefer-able. When C exceeds 0.010 mass %, the iron loss is remarkably increased by magnetic aging so that the upper limit of C is 0.010 mass %. Preferably, it is not more than 0.005 mass %. Also, a lesser amount of C is more preferable and therefore a lower limit is not particularly limited.

Si: 1-4 mass %

Si is an element generally added as a deoxidizing agent of steel. In electrical steel sheets, however, it is an important element having an effect of increasing an electrical resistance to decrease an iron loss at a high frequency so that it is necessary to add in an amount of not less than 1 mass % to obtain such an effect. However, when it exceeds 4 mass %, an excitation effective current is considerably increased so that the upper limit is set to 4 mass %. Preferably, it is 1.0-3.5 mass %.

Mn: 0.05-3 mass %

Mn has an effect of preventing hot brittleness during the hot rolling of steel to prevent generation of surface defects so that it is added in an amount of not less than 0.05 mass %. On the other hand, as Mn content becomes higher, the magnetic flux density and the saturated magnetic flux density are decreased so that the upper limit of Mn content is 3 mass %. Preferably, it is 0.1-1.7 mass %.

Al: not more than 0.004 mass %

When Al is decreased, the texture of the finish-annealed steel sheet can be improved to increase the magnetic flux density. Also, the decrease of Al is necessary to promote grain boundary segregation of P to increase the magnetic flux density. When it exceeds 0.004 mass %, such an effect cannot be obtained. Accordingly, the upper limit of Al is 0.004 mass %. Preferably, it is not more than 0.002 mass %. Moreover, the lower limit of Al is not particularly limited because a lesser amount is more preferable.

N: not more than 0.005 mass %

N forms a nitride to deteriorate magnetic properties so that it is limited to not more than 0.005 mass %. Preferably, it is not more than 0.002 mass %. The lower limit is not particularly limited because a lesser amount is more preferable.

P: 0.03-0.20 mass %

P is one of important elements and has an effect of increasing the magnetic flux density by segregation into the grain boundary in the Al-less steel as shown in FIG. 1. Such an effect is obtained with an addition of not less than 0.03 mass %. While, when it exceeds 0.20 mass %, it is difficult to perform cold rolling. Therefore, the addition amount of P is 0.03-0.20 mass %. Preferably, it is 0.05-0.10 mass %.

S: not more than 0.01 mass %

S is an element forming a sulfide such as MnS or the like to deteriorate magnetic properties of a product so that a lesser amount is more preferable. Therefore, the upper limit of S is 0.01 mass % to not deteriorate the magnetic properties. It is preferably not more than 0.005 mass %, more preferably not more than 0.001 mass % from a viewpoint of promoting the grain boundary segregation of P. Moreover, the lower limit is not particularly limited because a lesser amount is more preferable.

Se: not more than 0.002 mass %

Since Se is a harmful element segregating into the grain boundary earlier than P to suppress the grain boundary segregation of P and decrease the magnetic flux density so that it is necessary to decrease Se as much as possible. Therefore, the upper limit is 0.002 mass %. Preferably, it is not more than 0.001 mass %.

However, Sn and Sb described later have an effect of inhibiting the harmful effect of Se so that when Sn and Sb are added, the upper limit of Se can be expanded to 0.003 mass %. In this case, Se is preferably not more than 0.0025 mass %.

The non-oriented electrical steel sheet may contain one or more selected from Sn, Sb, Ca and Mg within the following range in addition to the above essential ingredients.

Sn: 0.001-0.1 mass %

Sn is an element segregating into the grain boundary, but has little influence on P segregation and, rather, has an effect of accelerating formation of a deformable band inside grains to increase the magnetic flux density. Such an effect is obtained with an addition of not less than 0.001 mass %. While, when it is added in an amount exceeding 0.1 mass %, embrittlement of steel is caused to increase surface defects such as fracture of the sheet, scab and the like in the production process. Therefore, when Sn is added, it is preferably 0.001-0.1 mass %. More preferably, it is 0.001-0.06 mass %.

Sb: 0.001-0.1 mass %

Sb is an element segregating into the grain boundary like Sn, but has little influence on P segregation and, rather, has an effect of suppressing nitriding in the annealing to improve the magnetic properties. Such an effect is obtained with an addition of not less than 0.001 mass %. On the other hand, when it is added in an amount exceeding 0.1 mass %, embrittlement of steel is caused to increase surface defects such as fracture of the sheet, scab and the like in the production process. Therefore, when Sb is added, it is preferably 0.001-0.1 mass %. More preferably, it is 0.001-0.06 mass %.

Ca: 0.001-0.005 mass %

Ca has an effect of coarsening sulfide to decrease an iron loss so that it can be added in an amount of not less than 0.001 mass %. On the other hand, if it is exceedingly added, the above effect is saturated and is economically disadvantageous. Therefore, the upper limit is 0.005 mass %. More preferably, it is 0.001-0.003 mass %.

Mg: 0.001-0.005 mass %

Mg has an effect of coarsening sulfide to decrease an iron loss like Ca so that it can be added in an amount of not less than 0.001mass %. On the other hand, if it is exceedingly added, the above effect is saturated and is economically disadvantageous. Therefore, the upper limit is 0.005 mass %. More preferably, it is 0.001-0.003 mass %.

The remainder other than the above ingredients in the non-oriented electrical steel sheet is Fe and inevitable impurities. However, an addition of other elements may not be refused within a range not damaging the desired effect.

Next, the thickness (product thickness) of the non-oriented electrical steel sheet will be described below.

The thickness of the non-oriented electrical steel sheet is preferably not more than 0.30 mm from a viewpoint of reducing iron loss at a high frequency zone. While, when the thickness is less than 0.05 mm, there are caused such problems that the lamination number required for the production of an iron core is increased and the rigidity of the steel sheet is extremely decreased to increase vibration of a motor and so on. Therefore, the thickness is preferably 0.05-0.30 mm. More preferably, it is 0.10-0.20 mm.

Next, the method of producing the non-oriented electrical steel sheet will be described.

In the non-oriented electrical steel sheet, a well-known production method for a non-oriented electrical steel sheet can be used as long as a slab containing Al, P and Se in the above-described proper ranges is used as a raw material thereof and is not particularly limited. For example, there can be adopted the following method or a method in which a steel adjusted to have a predetermined chemical composition is melted by a refining process such as a converter, electric furnace or the like, subjected to a secondary refining with a degassing device or the like and continuously casted to obtain a steel slab, which is subjected to hot rolling, hot band annealing as required, pickling, cold rolling, finish annealing and further coating and baking of an insulating film.

Moreover, when the hot band annealing is performed, a soaking temperature is preferably 900-1200° C. When it is lower than 900° C., the effect by the hot band annealing cannot be sufficiently obtained and the magnetic properties are not improved, while when it exceeds 1200° C., the cost becomes disadvantageous and the grain size in the hot rolled sheet becomes coarsened to bring about a fear of causing a breakage in the cold rolling.

Also, the cold rolling of the hot rolled sheet to a final thickness is preferable to be once or twice or more including intermediate annealing therebetween. Particularly, the final cold rolling is preferably warm rolling at a sheet temperature of approximately 200° C. unless there is a problem in equipment, production constraint or cost, because the warm rolling has a large effect of increasing the magnetic flux density.

The finish annealing applied to the cold rolled sheet with a final thickness is preferably a continuous annealing of soaking at a temperature of 900-1150° C. for 5-60 seconds. When the soaking temperature is lower than 900° C., recrystallization is not sufficiently advanced and good magnetic properties cannot be obtained. While, when it exceeds 1150° C., crystal grains are coarsened and the iron loss particularly at a high frequency zone is increased.

It is preferable that an insulation coating is formed on the surface of the steel sheet after the finish annealing to decrease iron loss. As the insulation coating is desirably used a semi-organic insulation coating containing a resin to ensure good punchability.

The non-oriented electrical steel sheet thus produced may be used without stress-relief annealing or may be used after the stress-relief annealing. Alternatively, the stress relief annealing may be conducted after the shaping through a punching process. The stress relief annealing is generally conducted at 750° C. for 2 hours.

### EXAMPLE

A steel having a chemical composition as shown in Table 1 and the remainder being Fe and inevitable impurities is melted and continuously casted to obtain a steel slab, which is heated at a temperature of 1140° C. for 1 hour and subjected to hot rolling at a finish rolling end temperature of 800° C. and a coiling temperature of 610° C. to obtain a hot rolled sheet having a thickness of 1.6 mm. The hot rolled sheet is subjected to a hot band annealing at 1000° C. for 30 seconds and then cold rolled to obtain a cold rolled sheet having a thickness shown in Table 1. Subsequently, the cold rolled sheet is subjected to a finish annealing of holding a temperature shown in Table 1 for 10 seconds to obtain a cold rolled and annealed sheet (non-oriented electrical steel sheet).

From the cold rolled and annealed sheet thus obtained are cut out Epstein test specimens with a width of 30 mm and a length of 280 mm in the rolling direction (L-direction) and in a direction perpendicular to the rolling direction (C-direction) as a longitudinal direction, respectively, and the magnetic flux density B₅₀ (T) and iron loss W_{10/400} (W/kg) thereof are measured by a 25 cm Epstein method described in JIS C2550, results of which are also shown in Table 1.

TABLE 1

| | Chemical composition (mass %)* | | | | | | | | | |
|---|---|---|---|---|---|---|---|---|---|---|
| No | C | Si | Mn | Al | N | P | S | Se | Sn | Sb |
| 1 | 0.0019 | 3.01 | 0.15 | 0.0010 | 0.0018 | 0.010 | 0.0005 | 0.0001 | 0.0020 | 0.0001 |
| 2 | 0.0017 | 3.05 | 0.10 | 0.0010 | 0.0017 | 0.034 | 0.0005 | 0.0001 | 0.0020 | 0.0001 |
| 3 | 0.0012 | 3.04 | 0.12 | 0.0010 | 0.0012 | 0.051 | 0.0004 | 0.0001 | 0.0020 | 0.0001 |
| 4 | 0.0013 | 3.04 | 0.12 | 0.0010 | 0.0016 | 0.050 | 0.0015 | 0.0001 | 0.0020 | 0.0001 |
| 5 | 0.0018 | 3.05 | 0.13 | 0.0020 | 0.0017 | 0.050 | 0.0015 | 0.0001 | 0.0020 | 0.0001 |
| 6 | 0.0020 | 3.00 | 0.12 | 0.0010 | 0.0019 | 0.100 | 0.0005 | 0.0001 | 0.0020 | 0.0001 |
| 7 | 0.0017 | 3.01 | 0.15 | 0.0010 | 0.0018 | 0.010 | 0.0005 | 0.0001 | 0.0300 | 0.0001 |
| 8 | 0.0015 | 3.04 | 0.12 | 0.0010 | 0.0013 | 0.050 | 0.0004 | 0.0001 | 0.0300 | 0.0001 |
| 9 | 0.0017 | 3.01 | 0.15 | 0.0010 | 0.0018 | 0.010 | 0.0005 | 0.0001 | 0.0300 | 0.0001 |
| 10 | 0.0021 | 3.04 | 0.12 | 0.0010 | 0.0013 | 0.050 | 0.0004 | 0.0001 | 0.0300 | 0.0001 |
| 11 | 0.0022 | 3.01 | 0.15 | 0.0010 | 0.0018 | 0.010 | 0.0005 | 0.0001 | 0.0300 | 0.0001 |
| 12 | 0.0019 | 3.04 | 0.12 | 0.0010 | 0.0013 | 0.050 | 0.0004 | 0.0001 | 0.0300 | 0.0001 |
| 13 | 0.0020 | 2.81 | 0.16 | 0.0050 | 0.0014 | 0.050 | 0.0005 | 0.0001 | 0.0020 | 0.0001 |
| 14 | 0.0017 | 2.82 | 0.18 | 0.3000 | 0.0012 | 0.050 | 0.0005 | 0.0001 | 0.0020 | 0.0001 |
| 15 | 0.0012 | 3.01 | 0.14 | 0.0010 | 0.0018 | 0.050 | 0.0005 | 0.0005 | 0.0020 | 0.0001 |
| 16 | 0.0013 | 3.00 | 0.21 | 0.0010 | 0.0018 | 0.050 | 0.0005 | 0.0017 | 0.0020 | 0.0001 |
| 17 | 0.0013 | 3.00 | 0.21 | 0.0010 | 0.0018 | 0.050 | 0.0005 | 0.0025 | 0.0020 | 0.0001 |
| 18 | 0.0018 | 3.00 | 0.21 | 0.0010 | 0.0020 | 0.050 | 0.0005 | 0.0043 | 0.0020 | 0.0001 |
| 19 | 0.0022 | 2.80 | 0.21 | 0.3000 | 0.0023 | 0.050 | 0.0005 | 0.0001 | 0.0020 | 0.0001 |
| 20 | 0.0012 | 3.04 | 0.21 | 0.0010 | 0.0012 | 0.050 | 0.0005 | 0.0001 | 0.0020 | 0.0020 |
| 21 | 0.0015 | 3.10 | 0.20 | 0.0010 | 0.0025 | 0.050 | 0.0005 | 0.0001 | 0.0020 | 0.0300 |
| 22 | 0.0016 | 3.00 | 0.18 | 0.0010 | 0.0012 | 0.050 | 0.0005 | 0.0001 | 0.0025 | 0.0001 |
| 23 | 0.0014 | 3.05 | 0.17 | 0.0010 | 0.0019 | 0.050 | 0.0005 | 0.0001 | 0.0100 | 0.0001 |
| 24 | 0.0013 | 3.09 | 0.21 | 0.0010 | 0.0011 | 0.050 | 0.0005 | 0.0001 | 0.0500 | 0.0001 |
| 25 | 0.0019 | 2.99 | 0.21 | 0.0010 | 0.0019 | 0.050 | 0.0025 | 0.0001 | 0.0001 | 0.0001 |
| 26 | 0.0019 | 3.00 | 0.20 | 0.0010 | 0.0018 | 0.050 | 0.0025 | 0.0001 | 0.0001 | 0.0001 |
| 27 | 0.0020 | 3.00 | 0.21 | 0.0010 | 0.0022 | 0.050 | 0.0025 | 0.0001 | 0.0001 | 0.0001 |
| 28 | 0.0125 | 3.01 | 0.23 | 0.0010 | 0.0013 | 0.050 | 0.0005 | 0.0001 | 0.0020 | 0.0001 |
| 29 | 0.0021 | 0.70 | 0.19 | 0.0010 | 0.0018 | 0.050 | 0.0005 | 0.0001 | 0.0020 | 0.0001 |
| 30 | 0.0020 | 1.20 | 0.21 | 0.0010 | 0.0020 | 0.050 | 0.0005 | 0.0001 | 0.0020 | 0.0001 |
| 31 | 0.0016 | 2.00 | 0.21 | 0.0010 | 0.0023 | 0.050 | 0.0005 | 0.0001 | 0.0020 | 0.0001 |
| 32 | 0.0012 | 4.51 | 0.21 | 0.0010 | 0.0012 | 0.050 | 0.0005 | 0.0001 | 0.0020 | 0.0001 |
| 33 | 0.0013 | 3.00 | 1.20 | 0.0010 | 0.0016 | 0.050 | 0.0005 | 0.0001 | 0.0020 | 0.0001 |
| 34 | 0.0013 | 3.00 | 1.60 | 0.0010 | 0.0016 | 0.050 | 0.0005 | 0.0001 | 0.0020 | 0.0001 |
| 35 | 0.0019 | 3.01 | 3.50 | 0.0010 | 0.0012 | 0.050 | 0.0005 | 0.0001 | 0.0020 | 0.0001 |
| 36 | 0.0022 | 3.00 | 0.21 | 0.0010 | 0.0062 | 0.050 | 0.0020 | 0.0001 | 0.0020 | 0.0001 |
| 37 | 0.0021 | 3.00 | 0.21 | 0.0010 | 0.0020 | 0.050 | 0.0150 | 0.0001 | 0.0020 | 0.0001 |

| | | | | | Magnetic | | |
|---|---|---|---|---|---|---|---|
| | | | | | properties | | |
| | Chemical | | | Finish | Iron | Magnetic | |
| | composition | | | annealing | loss | flux | |
| | (mass %)* | | Thickness | temperature | W_{10/400} | density | |
| No | Ca | Mg | (mm) | (° C.) × 10 s | (W/kg) | B₅₀ (T) | Remarks |
| 1 | 0.0001 | 0.0001 | 0.20 | 980 | 12.00 | 1.65 | Comparative |
| | | | | | | | Example |
| 2 | 0.0001 | 0.0001 | 0.20 | 980 | 12.00 | 1.67 | Example |
| 3 | 0.0001 | 0.0001 | 0.20 | 980 | 12.00 | 1.68 | Example |
| 4 | 0.0001 | 0.0001 | 0.20 | 980 | 11.90 | 1.68 | Example |
| 5 | 0.0001 | 0.0001 | 0.20 | 980 | 11.80 | 1.68 | Example |
| 6 | 0.0001 | 0.0001 | 0.20 | 980 | 11.80 | 1.68 | Example |
| 7 | 0.0001 | 0.0001 | 0.15 | 980 | 10.00 | 1.65 | Comparative |
| | | | | | | | Example |
| 8 | 0.0001 | 0.0001 | 0.15 | 980 | 9.90 | 1.69 | Example |
| 9 | 0.0001 | 0.0001 | 0.10 | 980 | 8.41 | 1.63 | Comparative |
| | | | | | | | Example |
| 10 | 0.0001 | 0.0001 | 0.10 | 980 | 8.35 | 1.68 | Example |
| 11 | 0.0001 | 0.0001 | 0.05 | 980 | 7.32 | 1.62 | Comparative |
| | | | | | | | Example |
| 12 | 0.0001 | 0.0001 | 0.05 | 980 | 7.25 | 1.67 | Example |
| 13 | 0.0001 | 0.0001 | 0.20 | 980 | 12.90 | 1.65 | Comparative |
| | | | | | | | Example |
| 14 | 0.0001 | 0.0001 | 0.20 | 980 | 12.10 | 1.64 | Comparative |
| | | | | | | | Example |
| 15 | 0.0001 | 0.0001 | 0.20 | 980 | 12.10 | 1.69 | Example |
| 16 | 0.0001 | 0.0001 | 0.20 | 980 | 12.20 | 1.68 | Example |
| 17 | 0.0001 | 0.0001 | 0.20 | 980 | 12.40 | 1.66 | Comparative |
| | | | | | | | Example |
| 18 | 0.0001 | 0.0001 | 0.20 | 980 | 12.50 | 1.66 | Comparative |
| | | | | | | | Example |
| 19 | 0.0001 | 0.0001 | 0.20 | 980 | 12.10 | 1.64 | Comparative |
| | | | | | | | Example |
| 20 | 0.0001 | 0.0001 | 0.20 | 980 | 11.80 | 1.68 | Example |
| 21 | 0.0001 | 0.0001 | 0.20 | 980 | 11.60 | 1.69 | Example |
| 22 | 0.0001 | 0.0001 | 0.20 | 980 | 11.80 | 1.68 | Example |
| 23 | 0.0001 | 0.0001 | 0.20 | 980 | 11.70 | 1.69 | Example |
| 24 | 0.0001 | 0.0001 | 0.20 | 980 | 11.50 | 1.69 | Example |
| 25 | 0.0001 | 0.0001 | 0.20 | 980 | 12.00 | 1.67 | Example |
| 26 | 0.0020 | 0.0001 | 0.20 | 980 | 11.90 | 1.68 | Example |
| 27 | 0.0001 | 0.0020 | 0.20 | 980 | 11.90 | 1.68 | Example |
| 28 | 0.0001 | 0.0001 | 0.20 | 980 | 12.60 | 1.66 | Comparative |
| | | | | | | | Example |
| 29 | 0.0001 | 0.0001 | 0.20 | 980 | 14.90 | 1.74 | Comparative |
| | | | | | | | Example |
| 30 | 0.0001 | 0.0001 | 0.20 | 980 | 13.80 | 1.73 | Example |
| 31 | 0.0001 | 0.0001 | 0.20 | 980 | 12.70 | 1.72 | Example |
| 32 | 0.0001 | 0.0001 | 0.20 | 980 | 10.80 | 1.65 | Comparative |
| | | | | | | | Example |
| 33 | 0.0001 | 0.0001 | 0.20 | 980 | 11.40 | 1.68 | Example |
| 34 | 0.0001 | 0.0001 | 0.20 | 980 | 10.90 | 1.67 | Example |
| 35 | 0.0001 | 0.0001 | 0.20 | 980 | 11.50 | 1.65 | Comparative |
| | | | | | | | Example |
| 36 | 0.0001 | 0.0001 | 0.20 | 980 | 12.90 | 1.65 | Comparative |
| | | | | | | | Example |
| 37 | 0.0001 | 0.0001 | 0.20 | 980 | 13.10 | 1.64 | Comparative |
| | | | | | | | Example |

As seen from Table 1, our non-oriented electrical steel sheets having ingredients of Al, P and Se adjusted to acceptable ranges are high in the magnetic flux density and excellent in the iron loss property as compared to steel sheets of the comparative examples having the ingredients outside our ranges.

### INDUSTRIAL APPLICABILITY

The non-oriented electrical steel sheets are applicable to an electric power steering motor, a hard disk motor for an information device and so on.

1-4. (canceled)

5. A non-oriented electrical steel sheet having a chemical composition comprising C: not more than 0.010 mass %, Si: 1-4 mass %, Mn: 0.05-3 mass %, Al: not more than 0.004 mass %, N: not more than 0.005 mass %, P: 0.03-0.20 mass %, S: not more than 0.01 mass %, Se: not more than 0.002 mass % and the remainder being Fe and inevitable impurities.

6. A non-oriented electrical steel sheet having a chemical composition comprising C: not more than 0.010 mass %, Si: 1-4 mass %, Mn: 0.05-3 mass %, Al: not more than 0.004 mass %, N: not more than 0.005 mass %, P: 0.03-0.20 mass %, S: not more than 0.01 mass %, Se: not more than 0.003 mass %, one or two of Sn: 0.001-0.1 mass % and Sb: 0.001-0.1 mass % and the remainder being Fe and inevitable impurities.

7. The non-oriented electrical steel sheet according to claim 5, further containing one or two of Ca: 0.001-0.005 mass % and Mg: 0.001-0.005 mass %.

8. The non-oriented electrical steel sheet according to claim 5, having a thickness of 0.05-0.30 mm.

9. The non-oriented electrical steel sheet according to claim 6, further containing one or two of Ca: 0.001-0.005 mass % and Mg: 0.001-0.005 mass %.

10. The non-oriented electrical steel sheet according to claim 6, having a thickness of 0.05-0.30 mm.

11. The non-oriented electrical steel sheet according to claim 7, having a thickness of 0.05-0.30 mm.

12. The non-oriented electrical steel sheet according to claim 9, having a thickness of 0.05-0.30 mm.
